(19) United States
(12) Patent Application Publication
(10) Pub. No.: US 2026/0166661 A1
(43) Pub. Date: Jun. 18, 2026

(54) Jig for Repairing Tabs on Plastic Automotive Part

(71) Applicant: Six, Inc., Crystal Lake, IL (US)

(72) Inventor: Mario Dimovski, Crystal Lake, IL (US)

(21) Appl. No.: 19/425,423

(22) Filed: Dec. 18, 2025

Related U.S. Application Data
(60) Provisional application No. 63/735,388, filed on Dec. 18, 2024.

(51) Int. Cl. B23K 37/04; B23K 9/00; B23K 101/00

(52) U.S. Cl. CPC B23K 37/0443; B23K 9/00; B23K 2101/006

(57) ABSTRACT

A tab repair jig for automotive parts is disclosed herein as an innovative tool designed to facilitate the repair of broken or missing plastic tabs on vehicles. The jig can be designed to conform to common dimensions of vehicle bumpers and includes features for quality control, such as a secure clip mechanism and a gap for verifying repair thickness. Preferably the jig is manufactured from high-grade metal or durable alloys using 3D printing or casting techniques, to ensure efficient, high-quality repairs that meet industry standards and allow for proper reassembly. This invention offers a cost-effective and sustainable alternative to full bumper replacements, setting a new standard in automotive repair technology.

### RELATED APPLICATION

The present disclosure claims the filing priority of U.S. Provisional Application No. 63/735,388, titled “Jig For Repairing Tabs On Plastic Automotive Part” and filed on Dec. 18, 2024 (the '388 Provisional). The '388 Provisional application is hereby incorporated by reference.

### FIELD OF THE INVENTION

This disclosed invention relates to the field of automotive repair, specifically to tools and methods for repairing damaged tabs on plastic parts for vehicles. The invention provides a solution for securely reattaching broken or missing bumper tabs using a specially designed jig that also serves as a quality control tool for ensuring proper repair thickness.

### BACKGROUND OF THE INVENTION

In the automotive repair industry, bumper tabs are frequently broken or missing due to collisions or other causes of damage. The tabs are an essential element in attachment of a bumper, and other plastic parts, to a vehicle. Without each required tab, parts will not attach securely, which can lead to vibration, misalignment, aesthetic flaws, and excessive wear and strain on existing tabs. Repairing broken tabs has often required either a time-consuming process of fabricating new tabs or replacing the entire plastic part, which significantly increases repair costs and vehicle downtime. Additionally, improper repairs can lead to poor fitment during reassembly, compromising the quality and durability of the repair.

Accordingly, there is a need for a tool that can streamline the repair process of broken and missing tabs and thereby ensure both efficient and high-quality repairs. The tab repair jig disclosed herein addresses this need by providing a versatile tool that not only aids in the repair process but also ensures that the repaired tab meets the necessary thickness requirements for proper reassembly.

Until the invention of the present application, these and other problems in the prior art went either unnoticed or unsolved by those skilled in the art. The present invention provides a tab repair tool which, in a unique method of use, performs multiple functions without sacrificing features such as ease of use, quality, or precision.

### SUMMARY OF THE INVENTION

There is disclosed herein a novel tab repair jig which avoids the disadvantages of prior devices while affording additional structural and operating advantages.

Generally speaking, the disclosed tab repair jig is a tool designed to facilitate the repair of broken or missing tabs on plastic automotive parts, such as a bumper cover. The jig comprises a body, typically curved to correspond to the part being repaired, and at least two securing clips gapped from the body and spaced apart from one another to create an open area for tab repair. The gap provides a means for verifying the thickness of the tab weld to ensure the repaired tab will work properly in connecting back to the vehicle.

In specific embodiments, the jig is engineered to fit 60 mm×10 mm dimensions and curves of vehicle bumper tabs usually located at the tip of the bumper cover where it bolts onto the fender, the jigs also can be used on other parts with tab provisions such as grills, side skirts and fender liners, making it applicable to a wide range of vehicles. The tool includes a secure clip mechanism that acts as a quality control feature, ensuring that the weld thickness meets industry standards. Additionally, the jig has an open area that allows technicians to confirm that the thickness of the repaired tab is sufficient to fit into the slide panel during reassembly.

In specific embodiments, the jig can be manufactured from high-grade metal through advanced 3D printing technology, or it can be cast from durable alloys. These materials ensure that the jig is durable enough to withstand the high temperatures involved in the welding process and can be used repeatedly without losing its structural integrity.

In other specific embodiments the disclosed jigs are engineered to fit 40 mm tab dimensions and a 268.17 mm radius curve of plastic tabs located at the tip of the bumper cover where it bolts onto the fender or fender liner, for example. The jigs can also be used on other parts with tab provisions, such as grills, side skirts, and fender liners, making it applicable to a wide range of vehicle repairs. The preferred jigs include a secure clip mechanism that acts as a quality control feature, ensuring any weld thickness meets industry standards. Finally, embodiments of the disclosed jigs include an opening that allows technicians to confirm that the thickness of any repaired tab is sufficient to fit into the slide panel during reassembly.

These and other aspects of the invention may be understood more readily from the following description and the appended drawings.

### BRIEF DESCRIPTION OF THE DRAWINGS

For purposes of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a perspective top view of an embodiment of the disclosed tab repair jig.

FIG. 2 is another perspective view of the tab repair jig shown in FIG. 1.

FIG. 3 illustrates placing an embodiment of the disclosed jig onto an automotive part need repair of a broken tab.

FIG. 4 illustrates the jig of FIG. 3 being secured to the automotive part and the broken tab positioned within the open area of the jig.

FIG. 5 is a perspective view of a repaired tab in an embodiment of the disclosed jig.

FIG. 6 is a front view of a preferred embodiment of a flat jig and a curved jig.

FIG. 7 is a top view illustrating the step of grinding a channel into a damaged tab.

FIG. 8 is a top view illustrating the placement of a welding strip onto the damaged tab of FIG. 7.

FIG. 9 is a side view illustrating a preferred fuse welding process.

FIG. 10 is a perspective view illustrating the step of using the disclosed jig to check the tab thickness.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

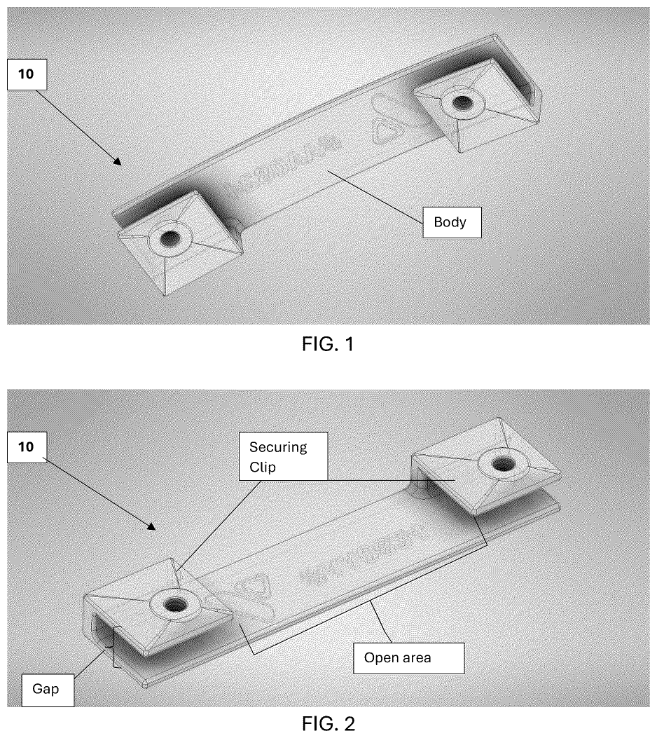

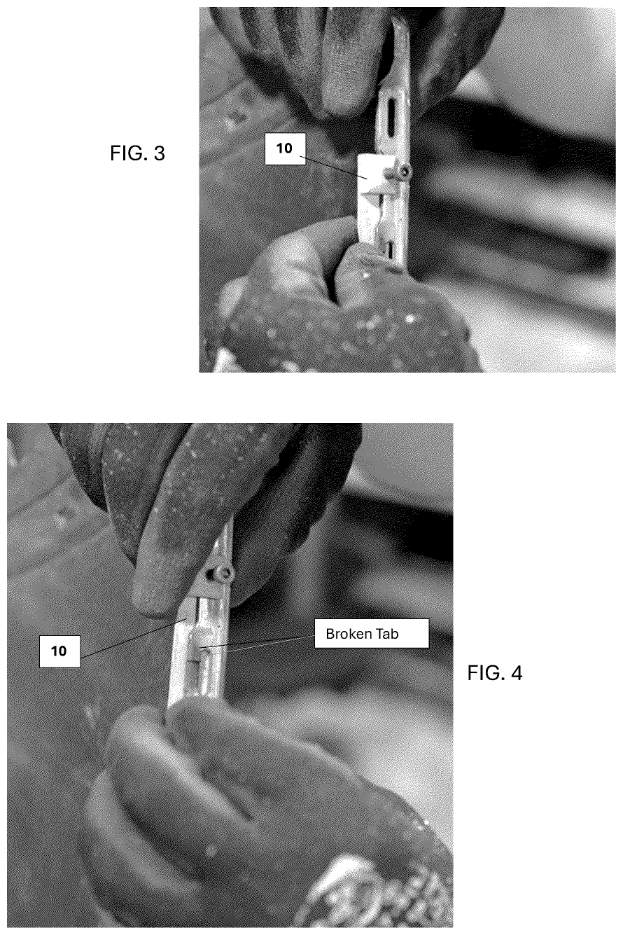

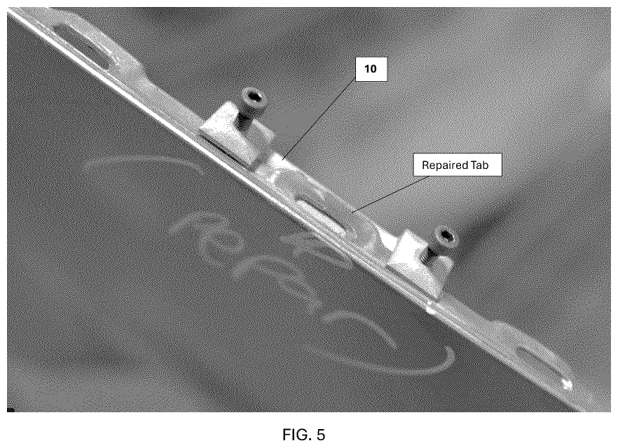

Referring to FIGS. 1-10, there is illustrated at least one embodiment of a tab jig, generally designated by the numeral 10. The illustrated jig 10 is for an automotive bumper. However, while all the embodiments illustrated are directed to a jig for a bumper tab, the principles of the invention can be more broadly applied to many automotive parts, as well as other types of connected or attachable parts, if the connection is accomplished via a plastic tab and slide panel.

Preferably, a standard tab repair jig 10 for purposes of most repair jobs should be designed to be 70 mm long by 15 mm deep and 10 mm high (roughly 2.76 inch×0.59 inch×0.39 inch) with a gap of approximately 40 mm (about 1.57 inch) to accommodate most tabs.

As can be seen in FIGS. 1 and 2, the jig 10 has an innovative yet simple design. The illustrated jig 10 is comprised of a body in a first plane, at least two securing clips in a second parallel plane and attached to the body, and a threaded pin for each securing clip, wherein a pin engages a threaded opening on a securing clip to move perpendicular to the parallel planes through a gap between the securing tabs and the body. An open area between adjacent securing clips provides a tab workspace. Further, the body of the jig 10 is curved slightly along a longitudinal axis running from end-to-end, as will be explained in greater detail below.

In a preferred embodiment, the tab repair jig 10 is specifically designed with its size being 70 mm long, by 15 mm deep, by 10 mm high, with an open area of about 40 mm to allow a plastic side tab to fit. These dimensions conform to common dimensions and curve of most vehicle bumpers, ensuring universal applicability. The open area can accommodate tabs up to 35 mm long and 4 mm thick. The jig 10 provides an easy way for technicians to check the weld during the repair process. Additionally, the jig 10 features a gap between the clip and the body that allows technicians to verify that the repair thickness is such that the tab will fit properly into the slide panel when bolting up, ensuring a secure and accurate reassembly.

As for material, the jig 10 is preferably manufactured from a high-grade metal that is ideal for high-temperature welding applications. Alternatively, the jig 10 can be cast from durable alloys, providing flexibility in the manufacturing process. Both materials are chosen for their ability to withstand repeated use and maintain the jig's structural integrity over time.

For manufacturing, the jig 10 is preferably produced using state-of-the-art metal 3D printing technology. This allows for rapid prototyping, customization, and production. Metal 3D printing also enables complex geometries and precise tolerances, ensuring the jig's effectiveness in the repair process. Additionally, traditional casting methods can be employed for mass production, offering a cost-effective alternative while maintaining high-quality standards.

Rigorous testing has been conducted to ensure that the jig 10 performs reliably under the conditions of fused welding. This includes testing for heat resistance, warping, and the ability to provide consistent support during the repair process. The jig's quality control features, such as the secure clip mechanism and thickness verification opening, have been validated to ensure that they consistently deliver accurate results, reducing the likelihood of rework and improving overall repair quality.

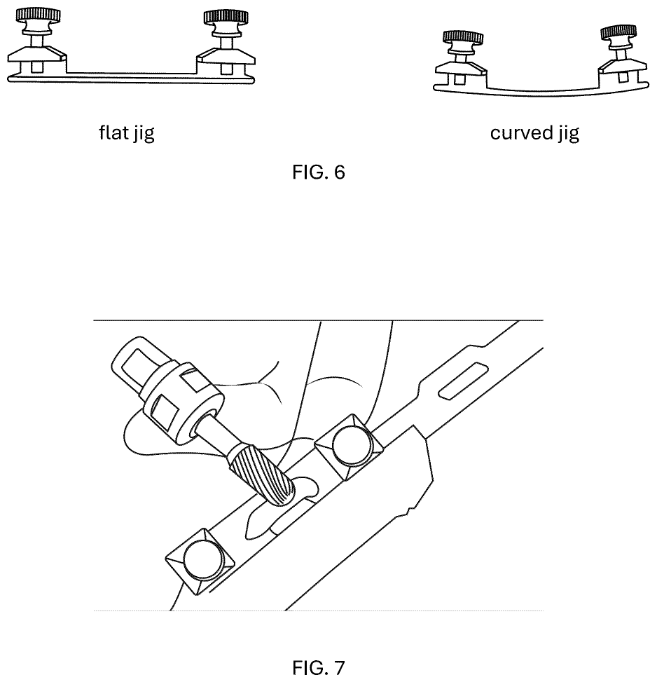

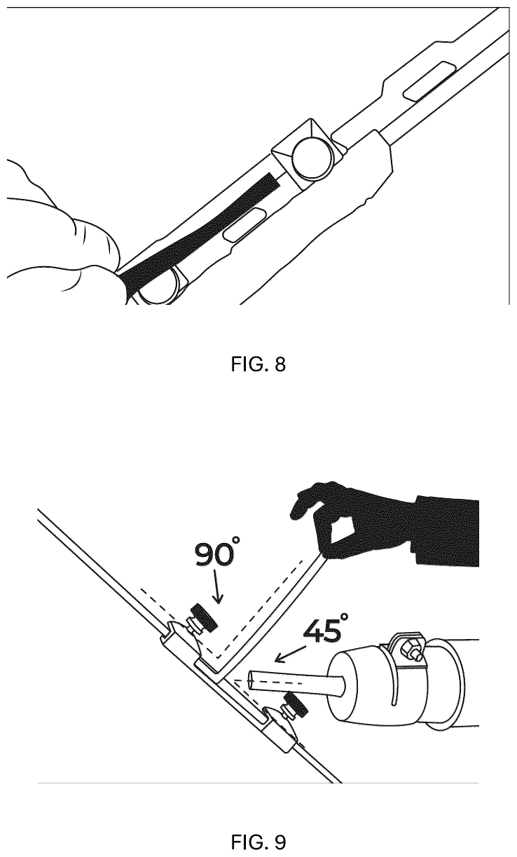

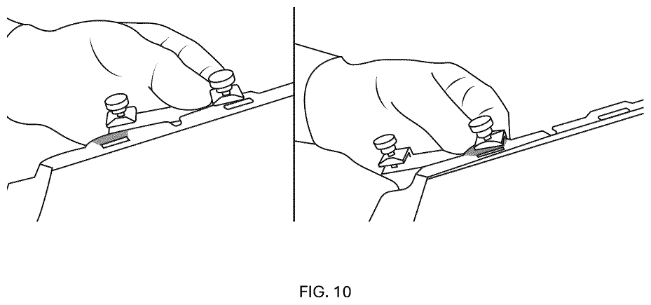

The following is a preferred embodiment outlining preferred steps for using the disclosed jigs 10 in a plastic automotive tab repair procedure:
1. Evaluate extent of damage to tab to determine if it is repairable. The entire automotive part should be inspected, looking for pre-existing damage, previous repairs made, and any broken or missing tabs.
2. Identify the plastic(s) used in construction of part and tab. If possible, locate a recycling/plastic ID code and look up the code to determine the material and whether it is weldable.
3. Create a repair plan for the damaged tab by marking the broken or missing section with a marker and highlighting where any channel and weld will begin and end on the damaged tab.
4. Securely mount the entire automotive part (e.g., bumper) on a suitable repair table, using spring clamps, cords, or the like to secure the part.
5. Select the appropriate tab jig to be used for the repair process—i.e., straight jig for tabs on a flat surface and curved jig for tabs on a curved surface (see FIG. 6). Be sure to have all necessary tools and P.P.E. available to make repair process as efficient as possible.
6. Align broken portions of the damaged tab, if necessary. Heat can be applied to aid in the alignment process if the tab is stretched or twisted out of shape.
7. Remove paint from tab to be repaired, being careful not to damage the edge of the automotive part. Tape may be helpful in protecting the edge.
8. Attach the selected tab repair jig onto the damaged tab by sliding it onto the tab and lightly tightening thumb screws, making sure the opening of the jig is aligned to allow access to the broken portion of the tab.
9. Using a die grinder (or similar tool) create a channel about three-quarters of the tab thickness deep, being sure to channel across the broken section of the tab (see FIG. 7). The channel should start on one side before the opening of the tab and continue to the opposite side of the opening. If a portion of the tab is missing, the ends of the remaining tab should be channelled to prepare for welding.
10. A plastic weld strip should be trimmed to fit the width of the tab, being sure not to extend into the opening (see FIG. 8).
11. Using a plastic welder, fuse weld across the broken or missing tab section, holding the welding strip at an approximate 90° angle to the surface of the part and the welder at approximately 45° angle (see FIG. 9). Downward pressure on the welding strip should be applied while heat is being directed to the point where the strip and tab meet. Multiple welds may be necessary, depending on the thickness of the tab.
12. Cool the welded area with compressed air, as necessary.
13. Remove tab repair jig from tab by loosening thumb screws and pulling jig outward from tab.
14. Using a disc grinder (or similar tool), level the welded tab surface.
15. Repeat steps 8 through 14 for the opposite surface of the damaged tab.
16. When both surfaces (i.e., top and bottom) of the tab have been welded and levelled, clean and shape the repaired tab using a disc grinder or similar tool.
17. Finish the repair using 180, 220, and 320 grit sandpaper.
18. Remove any protective tape applied to the automotive part.
19. Perform a thorough inspection of the repaired tab and automotive part to ensure quality of repair.
20. Using a tab repair jig, run screw connection portion of jig over repaired tab to confirm tab has been returned to OEM specifications (see FIG. 10).

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants'contribution. The actual scope of the protection sought is intended to be defined in the following claims when viewed in their proper perspective based on the prior art.

What is claimed is:

1. A jig for attachment to a plastic part to be used for repairing connection tabs on the plastic part, the jig comprising:
a body section having a first planar surface, two side edges, and two opposing ends;
first and second securing clips extending from the body section such that each is positioned within a second planar surface which is spaced a distance from, overlaps, and is substantially parallel to the first planar surface, thereby forming a gap between the two planar surfaces; and
an open area defined by the body section and the first and second securing clips;
wherein the jig is configured to be attached to a straight plastic part having a broken connection tab with the body section supporting the broken connection tab to allow repair.

2. The jig of claim 1, wherein the spaced distance forming the gap in the open area is configured to be a preferred size to check a repaired tab for thickness to allow the tab to fit into a corresponding slide panel.

3. The jig of claim 1, wherein the body comprises high-grade metal suitable for high-temperature welding.

4. The jig of claim 1, wherein the body comprises a cast durable metal alloy.

5. The jig of claim 1, wherein the first and second securing clips each further comprise a thumb screw for securing to a plastic part.

6. A jig for attachment to a plastic part to be used for repairing connection tabs on the plastic part, the jig comprising:
a body section having a first uniformly curved surface, two side edges, and two opposing ends;
first and second securing clips extending from the body section such that each overlaps and is spaced a distance from the body section, thereby forming a gap between the uniformly curved surface and the securing clips; and
an open area defined by the body section and the first and second securing clips;
wherein the jig is configured to be attached to a curved plastic part having a broken connection tab with the body section supporting the broken connection tab to allow repair.

7. The jig of claim 6, wherein the spaced distance forming the gap in the open area is configured to be a preferred size to check a repaired tab for thickness to allow the tab to fit into a corresponding slide panel.

8. The jig of claim 6, wherein the body comprises high-grade metal suitable for high-temperature welding.

9. The jig of claim 6, wherein the body comprises a cast durable metal alloy.

10. The jig of claim 6, wherein the first and second securing clips each further comprise a thumb screw for securing to a plastic part.

11. A method of using a tab repair jig to repair a broken tab on a plastic part, the method comprising:
attaching a tab repair jig having a body section and first and second securing clips to a side of the plastic part;
utilizing the first and second securing clips and an open area between the securing clips to position a damaged connection tab on the plastic part;
performing a fused welding process to repair the damaged connection tab using the jig body as a support structure; and
ensuring the tab fits properly into a slide panel during reassembly.

12. The method of claim 11, wherein the jig body is curved to correspond to a curve of the plastic part being repaired.
